(19) United States
(12) Patent Application Publication
(10) Pub. No.: US 2026/0285053 A1
(43) Pub. Date: Sep. 24, 2026

(54) LIQUID CIRCULATION APPARATUS AND LIQUID DISCHARGE APPARATUS

(71) Applicant: Yuuta AOKI, Kanagawa (JP)

(72) Inventor: Yuuta AOKI, Kanagawa (JP)

(73) Assignee: Ricoh Company, Ltd., Tokyo (JP)

(21) Appl. No.: 19/532,324

(22) Filed: Feb. 6, 2026

(30) Foreign Application Priority Data
Mar. 18, 2025 (JP) 2025-044075

(51) Int. Cl. B41J 2/18; B41J 2/17; B41J 2/175

(52) U.S. Cl. CPC B41J 2/18; B41J 2/1721; B41J 2/17563; B41J 2/17596

(57) ABSTRACT

A liquid circulation apparatus includes: a head to: discharge a liquid from a nozzle; and circulate the liquid that is not discharged from the nozzle; and a liquid container to: store the liquid to be supplied to the head; and store the liquid collected from the head; a waste liquid container to store waste liquid of the liquid collected from the head; a first liquid feeder to feed the liquid from the liquid container to the head in a first feeding direction; a second liquid feeder to feed the liquid from the head to the liquid container or the waste liquid container in a second feeding direction; and a filter disposed at least: between the first liquid feeder and the head; or between the second liquid feeder and the head.

### CROSS-REFERENCE TO RELATED APPLICATIONS

This patent application is based on and claims priority pursuant to 35 U.S.C. § 119(a) to Japanese Patent Application No. 2025-044075, filed on Mar. 18, 2025, in the Japan Patent Office, the entire disclosure of which is hereby incorporated by reference herein.

### BACKGROUND

### Technical Field

The present embodiment relates to a liquid circulation apparatus and a liquid discharge apparatus.

### Related Art

As a liquid discharge head (hereinafter, also referred to as a “head”.), there is a flow-through head (circulative head) including a supply channel to an individual liquid chamber in communication with a nozzle, a discharge channel leading to the individual liquid chamber, a liquid inlet leading to the supply channel, and a liquid outlet leading to the discharge channel.

For a printer equipped with an inkjet head, for example, there is an ink circulation technique using a diaphragm pump for supply of ink to a head, prevention of drying of the ink in a head tank, and degassing.

### SUMMARY

The present disclosure described herein provides a liquid circulation apparatus includes: a head to: discharge a liquid from a nozzle; and circulate the liquid that is not discharged from the nozzle; and a liquid container to: store the liquid to be supplied to the head; and store the liquid collected from the head; a waste liquid container to store waste liquid of the liquid collected from the head; a first liquid feeder to feed the liquid from the liquid container to the head in a first feeding direction; a second liquid feeder to feed the liquid from the head to the liquid container or the waste liquid container in a second feeding direction; a filter disposed at least: between the first liquid feeder and the head; or between the second liquid feeder and the head; and a three-way valve disposed: between the first liquid feeder and the waste liquid container; or between the second liquid feeder and the waste liquid container, to switch a path between: a circulation path to circulate the liquid from the head to the liquid container; or a waste liquid path to discharge a waste liquid from the filter to the waste liquid container.

### BRIEF DESCRIPTIONS OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of a liquid circulation apparatus according to a first embodiment;

FIG. 2 is a schematic diagram illustrating a circulation system for a liquid circulation apparatus according to the present embodiment;

FIG. 3 is a schematic diagram illustrating an example of the liquid circulation apparatus according to the first embodiment;

FIG. 4 is a block diagram illustrating a functional block configuration of the liquid circulation apparatus according to the first embodiment;

FIG. 5 is a block diagram illustrating a hardware block configuration of the liquid circulation apparatus according to the first embodiment;

FIG. 6 is a flowchart illustrating an exemplary collection operation in a method for controlling the liquid circulation apparatus according to the first embodiment;

FIG. 7 is a schematic diagram of a liquid circulation apparatus according to a second embodiment;

FIG. 8 is a schematic diagram illustrating an example of the liquid circulation apparatus according to the second embodiment;

FIG. 9 is a block diagram illustrating a hardware block configuration of the liquid circulation apparatus according to the second embodiment;

FIG. 10 is a flowchart illustrating an exemplary collection operation in a method for controlling the liquid circulation apparatus according to the second embodiment;

FIG. 11 is a schematic diagram of a liquid circulation apparatus according to a third embodiment;

FIG. 12 is a schematic diagram illustrating an example of the liquid circulation apparatus according to the third embodiment;

FIG. 13 is a block diagram illustrating a hardware block configuration of the liquid circulation apparatus according to the third embodiment; and

FIG. 14 is a flowchart illustrating an exemplary collection operation in a method for controlling the liquid circulation apparatus according to the third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Liquid Circulation Apparatus

### First Embodiment

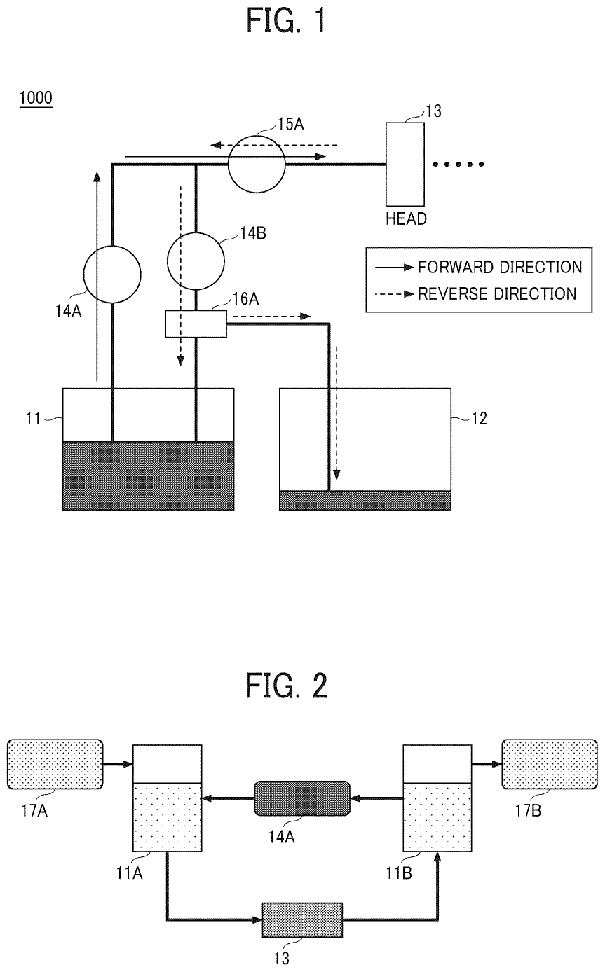

A first embodiment will be described below with reference to the accompanying drawings. An exemplary liquid circulation apparatus according to the first embodiment will be described with reference to FIG. 1. FIG. 1 is a schematic diagram of the liquid circulation apparatus according to the first embodiment.

A liquid circulation apparatus 1000 according to the first embodiment includes a circulation path in which liquid circulates through a liquid discharge head 13. The liquid circulation apparatus 1000 operates while making a switch as appropriate between an operation of discharging ink (hereinafter, also referred to as a “discharge operation”) and an operation of collecting the liquid in the circulation path (hereinafter, also referred to as a “collection operation”). Referring to FIG. 1, the flow of liquid in the discharge operation is indicated with solid arrows and the flow of liquid in the collection operation is indicated with broken arrows. The liquid discharge head 13 is referred to also as “a head 13”.

As illustrated in FIG. 1, the circulation path includes a liquid container 11, a waste liquid container 12, a liquid discharge head 13, a first liquid feeder 14A, a second liquid feeder 14B, a first filter 15A, and a three-way valve 16A. The first liquid feeder 14A is referred to also as “a first liquid feeding pump”, and the second liquid feeder 14A is referred to also as “a second liquid feeding pump”.

The liquid container 11 corresponds to a container that stores liquid. At the time of the discharge operation, the liquid stored in the liquid container 11 is supplied to the liquid discharge head 13 by the first liquid feeder 14A. In this case, the first filter 15A captures any foreign matter contained in the liquid. Thus, defective discharging is inhibited from occurring in the liquid discharge head 13, leading to a high discharge stability.

The waste liquid container 12 corresponds to a container that stores waste liquid. The waste liquid means the liquid that circulates in the circulation path and contains foreign matter. At the time of the collection operation, the liquid remaining in the liquid discharge head 13 is collected into the liquid container 11 or the waste liquid container 12 by the second liquid feeder 14B. In this case, the three-way valve 16A is controlled to open or close, so that the foreign matter captured by the first filter 15A is collected into the waste liquid container 12 and the liquid free of foreign matter is collected into the liquid container 11. The collection operation enables efficient removal of any foreign matter in the circulation path with a long filter lifetime.

FIG. 2 is a schematic diagram illustrating a circulation system for a liquid circulation apparatus according to the present embodiment.

Referring to FIG. 2, a circulative head 13 is disposed between a supply tank 11A and a collection tank 11B and a positive pressure and a negative pressure are applied to the supply tank 11A and the collection tank 11B, respectively, so that ink flows to the circulative head 13 due to the difference in pressure between the supply tank 11A and the collection tank 11B.

The ink flowing from the supply tank 11A to the collection tank 11B is returned from the collection tank 11B to the supply tank 11A by a liquid feeding feeder 14A (liquid feeding pump) between the collection tank 11B and the supply tank 11A.

An outflow of ink from the supply tank 11A causes an increase in the volume of air in the supply tank 11A, resulting in a reduction in the pressure in the supply tank 11A. A positive-pressure air pump 17A connected to the supply tank 11A pumps in air by the amount of reduction in pressure to keep the pressure in the supply tank 11A constant.

An inflow of ink into the collection tank 11B causes a reduction in the volume of air in the collection tank 11B, resulting in a rise in the pressure in the collection tank 11B (reduction in negative pressure). A negative-pressure air pump 17B connected to the collection tank 11B pumps out air by the amount of rise in pressure (amount of reduction in negative pressure) to keep the pressure in the collection tank 11B constant.

In a case where the ink in the supply tank 11A decreases and the ink in the collection tank 11B increases, it is necessary to return the ink from the collection tank 11B to the supply tank 11A using the liquid feeding feeder 14A (liquid feeding pump).

In this case, feeding the ink into the supply tank 11A causes a reduction in the volume of air in the supply tank 11A, resulting in a rise in the pressure in the supply tank 11A. Similarly, feeding the ink out from the collection tank 11B causes an increase in the volume of air in the collection tank 11B, resulting in a reduction in the pressure in the collection tank 11B.

In this case, since the positive-pressure air pump 17A only pumps in air, even in case where a rise is made in the pressure of the supply tank 11A, no pressure control can be performed using the positive-pressure air pump 17A. Thus, it is necessary to wait until a reduction is made in the pressure in the supply tank 11A due to an outflow of ink from the supply tank 11A to the collection tank 11B. Thus, pulsation occurs in the pressure in the supply tank 11A.

Similarly, since the negative-pressure air pump 17B only pumps out air, even in a case where a reduction is made in the pressure of the collection tank 11B (rise in negative pressure), no pressure control can be performed using the negative-pressure air pump 17B. Thus, it is necessary to wait until a rise is made in the pressure of the collection tank 11B (reduction in negative pressure) due to the ink flowing in the collection tank 11B. Thus, pulsation occurs in the pressure in the collection tank 11B.

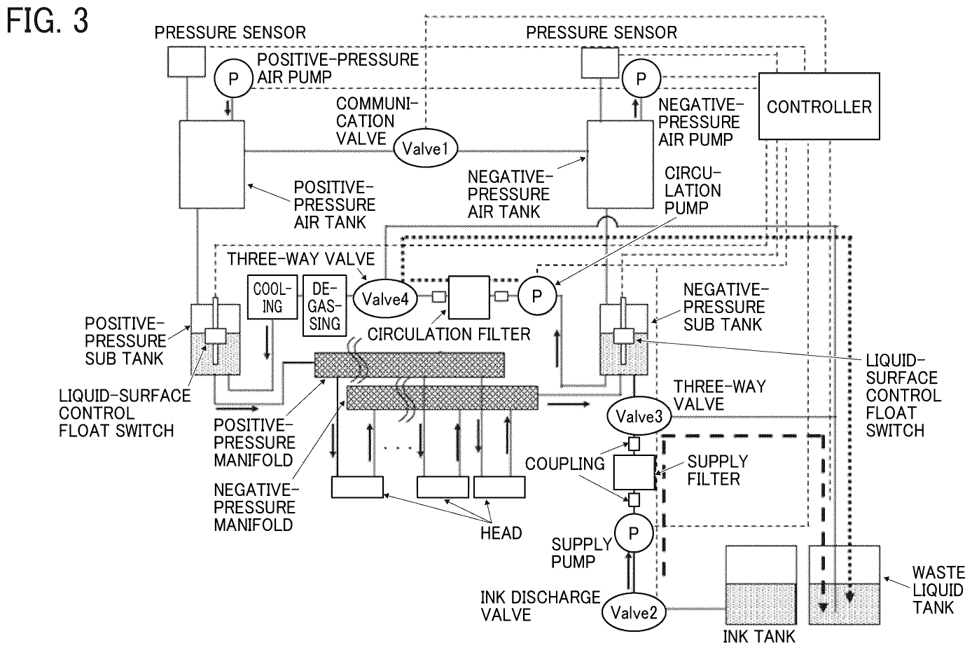

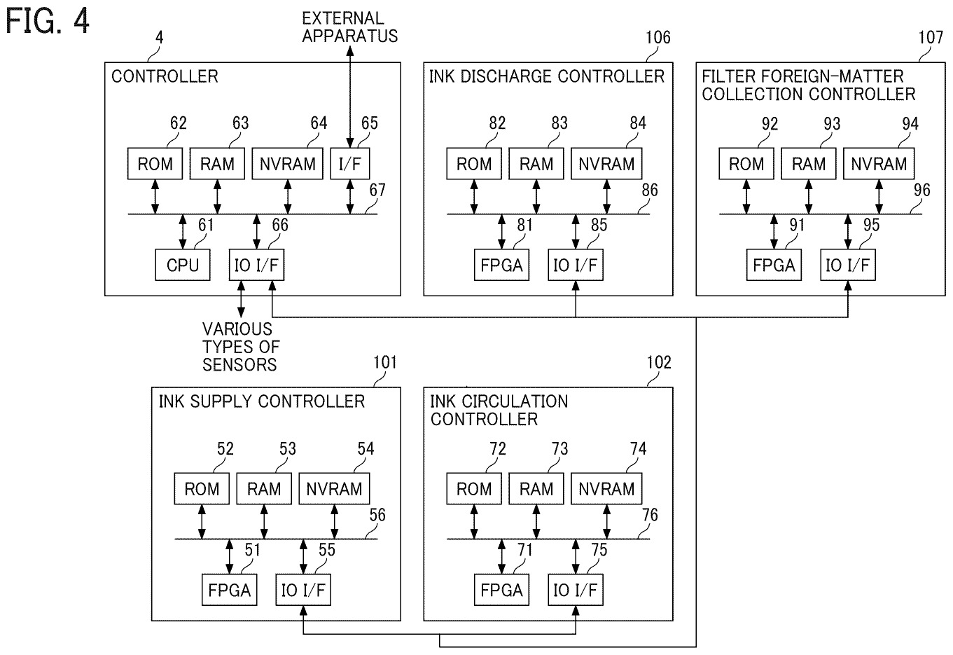

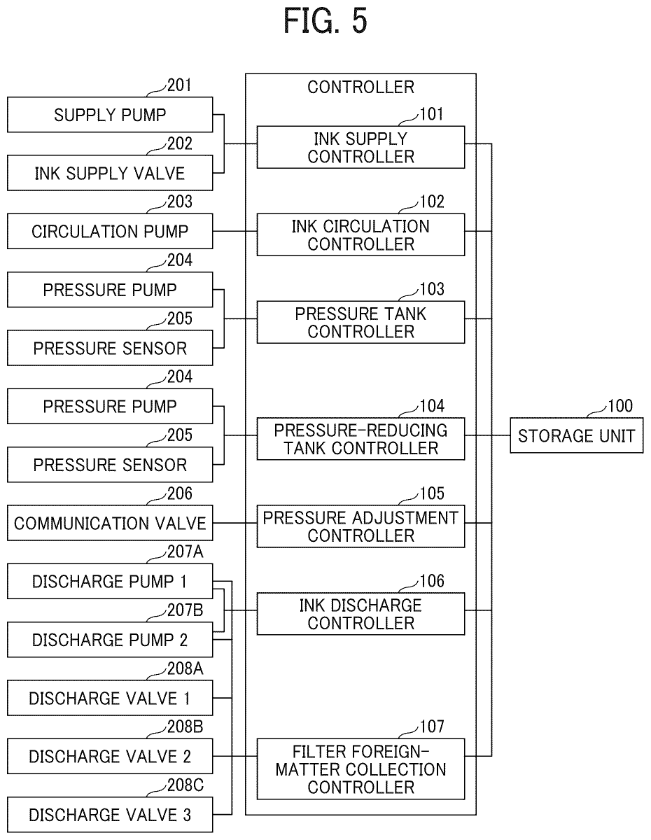

FIG. 3 is a schematic diagram illustrating an example of the liquid circulation apparatus according to the first embodiment. FIG. 4 is a block diagram illustrating a functional block configuration of the liquid circulation apparatus according to the first embodiment. FIG. 5 is a block diagram illustrating a hardware block configuration of the liquid circulation apparatus according to the first embodiment. Referring to FIG. 3, the flow of liquid in the discharge operation is indicated with solid arrows and the flow of liquid in the collection operation is indicated with broken arrows.

The liquid circulation apparatus according to the first embodiment includes a storage unit 100 as illustrated in FIG. 5, and the storage unit 100 is connected to a control unit that controls the liquid circulation apparatus.

The control unit includes an ink supply controller 101, an ink circulation controller 102, a pressure-tank controller 103, a pressure-reducing tank controller 104, a pressure adjustment controller 105, an ink discharge controller 106, and a filter foreign-matter collection controller 107.

The ink supply controller 101 is connected to a supply pump 201 and an ink supply valve 202 and controls the supply pump 201 and the ink supply valve 202.

Control of the supply pump 201 causes liquid to be supplied from the liquid container 11 to the liquid discharge head 13. Control of the ink supply valve 202 causes waste liquid containing foreign matter to be collected into the waste liquid container 12.

The ink circulation controller 102 is connected to a circulation pump 203 and controls the circulation pump 203.

The pressure-tank controller 103 is connected to a pressure pump 204 and a pressure sensor 205 and controls the pressure pump 204 and the pressure sensor 205.

The pressure-reducing tank controller 104 is connected to a pressure pump 204 and a pressure sensor 205 and controls the pressure pump 204 and the pressure sensor 205.

The pressure adjustment controller 105 is connected to a communication valve 206 and controls the communication valve 206.

The ink discharge controller 106 is connected to discharge pumps 207A and 207B and controls the discharge pumps 207A and 207B.

The filter foreign-matter collection controller 107 is connected to the discharge pumps 207A and 207B and discharge valves 208A, 208B, and 208C and controls the discharge pumps 207A and 207B and the discharge valves 208A, 208B, and 208C.

A hardware configuration of a controller 4, the ink supply controller 101, the ink circulation controller 102, the ink discharge controller 106, and the filter foreign-matter collection controller 107 of the liquid circulation apparatus according to the first embodiment will be described with FIG. 4.

As illustrated in FIG. 4, the controller 4 includes a central processing unit (CPU) 61, a read only memory (ROM) 62, a random access memory (RAM) 63, a non-volatile (NV) RAM 64, an interface (I/F) 65, and an input/output (IO) interface 66 that are connected through a memory bus 67. Note that the memory bus 67 may include a plurality of buses in separation.

The ink supply controller 101 includes a field programmable gate array (FPGA) 51, a ROM 52, a RAM 53, a NVRAM 54, and an IO interface 55 that are connected through a bus 56.

The ink circulation controller 102 includes a FPGA 71, a ROM 72, a RAM 73, a NVRAM 74, and an IO interface 75 that are connected through a bus 76.

The ink discharge controller 106 includes a FPGA 81, a ROM 82, a RAM 83, a NVRAM 84, and an IO interface 85 that are connected through a bus 86.

The filter foreign-matter collection controller 107 includes a FPGA 91, a ROM 92, a RAM 93, a NVRAM 94, and an IO interface 95 that are connected through a bus 96.

The CPU 61 in the controller 4 controls the entirety of the liquid circulation apparatus 1000.

The ROM 62 stores, for example, various types of information and various types of control programs.

The RAM 63 is used as a work area in a case where various types of processing is performed. For example, with the RAM 63 as a work area, the CPU 61 executes the various types of control programs stored in the ROM 62 to output control commands for control of various types of operations in the liquid circulation apparatus 1000. In this case, the CPU 61 controls various types of operations in the liquid circulation apparatus 1000 in cooperation with the FPGA 51 in the ink supply controller 101, the FPGA 71 in the ink circulation controller 102, the FPGA 81 in the ink discharge controller 106, and the FPGA 91 in the filter foreign-matter collection controller 107 through communication.

The NVRAM 64 stores, for example, apparatus-unique information and updatable information.

The interface 65 mediates information exchange with an external apparatus, such as a host computer.

The IO interface 66 mediates information exchange with each unit in the apparatus. For example, the IO interface 55 of the ink supply controller 101, an input/output device such as an operation panel, and various types of sensors are connected to the IO interface 66. Examples of the various types of sensors include a home position sensor for the head 13, a paper position detection sensor that detects the position of a medium, and a sensor that detects an in-device environment such as temperature or humidity. Note that the NVRAM 64 may be detachably insertable.

The FPGA 51 of the ink supply controller 101 controls, for example, the supply pump 201 and the ink supply valve 202. For example, with the RAM 53 as a work area, the FPGA 51 selects an operation stored in the ROM 52 and outputs a control command for an instruction for ink supply to the head 13. In this case, the FPGA 51 controls various types of operations in the liquid circulation apparatus 1000 in cooperation with the CPU 61 through communication with the CPU 61 of the controller 4.

The ROM 52 of the ink supply controller 101 stores in advance information, such as the operation and stop of the pump for ink supply, the open/close of each valve, the degree of valve opening/closeting, and the flow rate of ink in accordance with the degree of valve opening/closeting.

Similarly to the configuration of the ink supply controller 101, the ink circulation controller 102, the ink discharge controller 106, and the filter foreign-matter collection controller 107 control various types of operations for ink circulation, ink discharge, and filter foreign collection.

Note that an example in which the controller 4 is provided to the liquid circulation apparatus 1000 has been described with FIGS. 4 and 5, but a computer (e.g., a personal computer (PC)) connected to the liquid circulation apparatus 1000 may have part of the function of the controller 4 or the entire function thereof. In that case, the connected PC has a printer driver installed in advance, and the printer driver generates, from image data, recording data to be transmitted to the liquid circulation apparatus 1000.

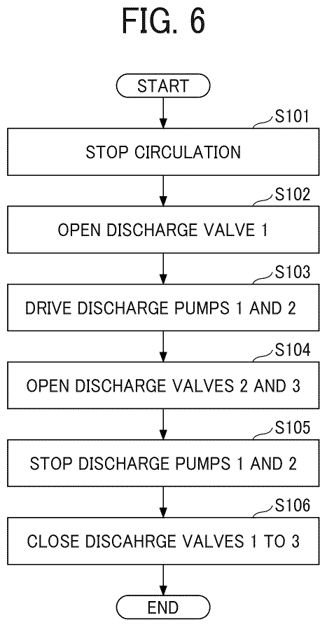

FIG. 6 is a flowchart illustrating an exemplary collection operation in a method for controlling the liquid circulation apparatus according to the first embodiment.

The collection operation in the method for controlling the liquid circulation apparatus (foreign-matter collection sequence) includes step S101 in which the liquid in the circulation path is stopped from circulating, step S102 in which an discharge valve 1 is opened, step S103 in which discharge pumps 1 and 2 are operated, step S104 in which discharge valves 2 and 3 are opened, step S105 in which the discharge pumps 1 and 2 are stopped, and step S106 in which the discharge valves 1 to 3 are close.

In step S101, the circulation of the liquid circulation apparatus is stopped simultaneously with the start of the collection operation (foreign-matter collection sequence).

In step S102, the discharge valve 1 is opened to release the liquid in the circulation system to the waste liquid container 12.

In step S103, the discharge pumps 1 and 2 are operated. Thus, the liquid in the circulation system is collected into the waste liquid container 12. In this case, the waste liquid containing the foreign matter captured by the first filter 15A is collected into the waste liquid container 12.

The time during which step S103 is performed is not particularly limited and can be selected as appropriate in accordance with the purpose. For example, step S103 can be performed for three seconds.

In step S104, the discharge valves 2 and 3 are opened, so that the liquid in the circulation system is collected into the liquid container 11. The liquid collected in the liquid container 11 can be reused.

In step S105, the discharge pumps 1 and 2 are stopped. Thus, the liquid in the circulation system is stopped from being collected into the liquid container 11.

In step S106, the discharge valves 1 to 3 are close, so that the collection operation (foreign-matter collection sequence) terminates.

### Second Embodiment

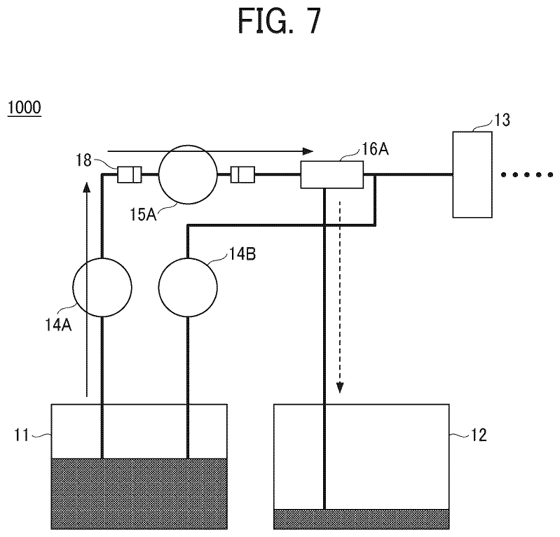

FIG. 7 is a schematic diagram illustrating a liquid circulation apparatus 1000 according to a second embodiment. In the following description of the liquid circulation apparatus 1000 according to the second embodiment, differences from the liquid circulation apparatus 1000 according to the first embodiment will be described and description of the already described matters will be partially omitted.

The liquid circulation apparatus 1000 according to the second embodiment includes a circulation path in which liquid circulates through a liquid discharge head 13.

As illustrated in FIG. 7, the circulation path includes a liquid container 11, a waste liquid container 12, a liquid discharge head 13, a first liquid feeder 14A, a second liquid feeder 14B, a first filter 15A, a three-way valve 16A, and a coupler 18.

The second embodiment is different from the first embodiment in that such a coupler 18 is disposed on the upstream side of the first filter 15A and another coupler 18 is disposed on the downstream side of the first filter 15A.

In the second embodiment, in a collection operation, the joints of the two couplers 18 are reversed to reverse the direction of the first filter 15A. In this state, the first liquid feeder 14A is driven, so that the foreign matter captured by the first filter 15A can be collected into the waste liquid container 12.

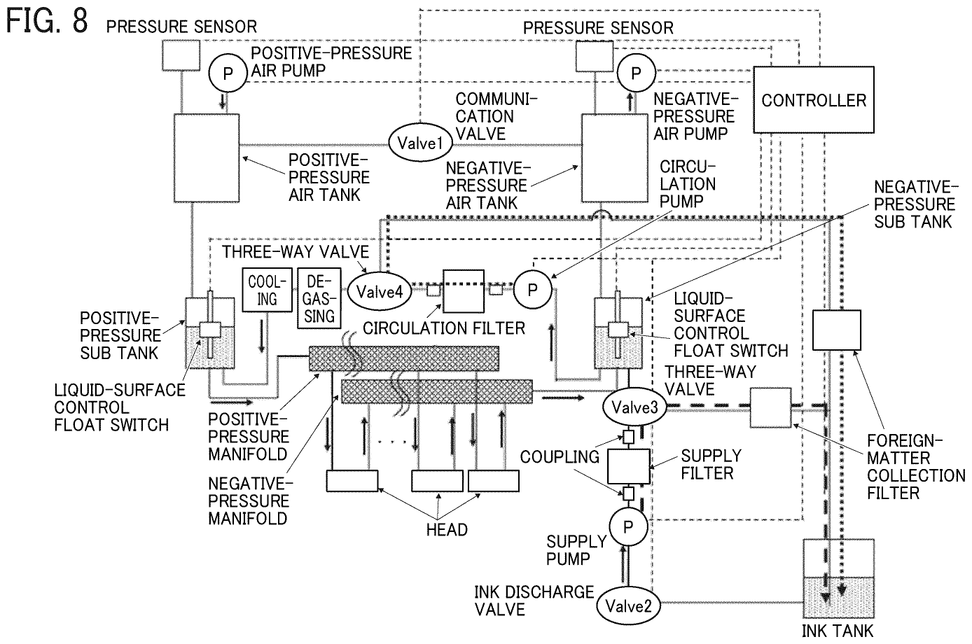

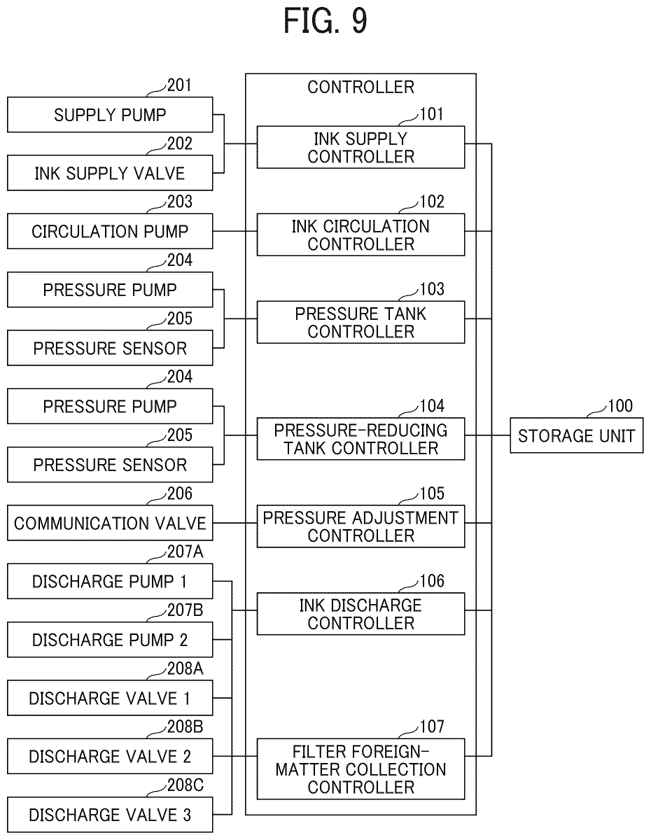

FIG. 8 is a schematic diagram of the liquid circulation apparatus according to the present embodiment. FIG. 9 is a block diagram illustrating a hardware block configuration of the liquid circulation apparatus according to the present embodiment. Referring to FIG. 8, the flow of liquid in a discharge operation is indicated with solid arrows and the flow of liquid in the collection operation is indicated with broken arrows.

The liquid circulation apparatus according to the second embodiment includes a storage unit 100 as illustrated in FIG. 9, and the storage unit 100 is connected to a control unit that controls the liquid circulation apparatus.

The control unit includes an ink supply controller 101, an ink circulation controller 102, a pressure-tank controller 103, a pressure-reducing tank controller 104, a pressure adjustment controller 105, an ink discharge controller 106, and a filter foreign-matter collection controller 107.

The ink supply controller 101 is connected to a supply pump 201 and an ink supply valve 202 and controls the supply pump 201 and the ink supply valve 202.

Control of the supply pump 201 causes liquid to be supplied from the liquid container 11 to the liquid discharge head 13. Control of the ink supply valve 202 causes waste liquid containing foreign matter to be collected into the waste liquid container 12.

The ink circulation controller 102 is connected to a circulation pump 203 and controls the circulation pump 203.

The pressure-tank controller 103 is connected to a pressure pump 204 and a pressure sensor 205 and controls the pressure pump 204 and the pressure sensor 205.

The pressure-reducing tank controller 104 is connected to a pressure pump 204 and a pressure sensor 205 and controls the pressure pump 204 and the pressure sensor 205.

The pressure adjustment controller 105 is connected to a communication valve 206 and controls the communication valve 206.

The ink discharge controller 106 is connected to discharge pumps 207A and 207B and discharge valves 208A, 208B, and 208C and controls the discharge pumps 207A and 207B and the discharge valves 208A, 208B, and 208C.

The filter foreign-matter collection controller 107 is connected to the discharge pumps 207A and 207B and the discharge valves 208A, 208B, and 208C and controls the discharge pumps 207A and 207B and the discharge valves 208A, 208B, and 208C.

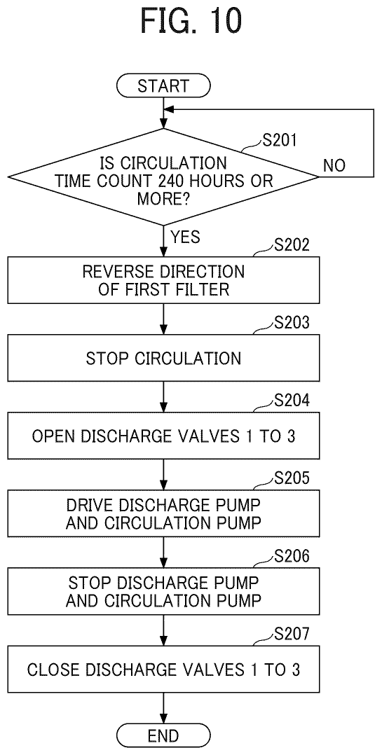

FIG. 10 is a flowchart illustrating an exemplary collection operation in a method for controlling the liquid circulation apparatus according to the present embodiment.

The collection operation in the method for controlling the liquid circulation apparatus (foreign-matter collection sequence) includes step S201 in which it is determined whether the circulation time count is 240 hours or more, step S202 in which the first filter is reversed, step S203 in which the liquid in the circulation path is stopped from circulating, step S204 in which discharge valves 1 to 3 are opened, step S205 in which a supply pump and a circulation pump are driven, step S206 in which the supply pump and the circulation pump are stopped, and step S207 in which the discharge valves 1 to 3 are close.

In step S201, it is determined whether the circulation time count is 240 hours or more. In a case where the circulation time count is not 240 hours or more, the liquid is circulated in the liquid circulation apparatus until the circulation time count fulfills 240 hours or more. In a case where the circulation time count is 240 hours or more, the processing proceeds to step S202. Note that the ink circulation controller 102 determines whether or not the circulation time count is 240 hours or more.

In step S202, the joints of the two couplers 18 are reversed to reverse the direction of the first filter 15A. In this state, the first liquid feeder 14A is driven, so that the foreign matter captured by the first filter 15A can be collected into the waste liquid container 12.

In step S203, the circulation of the liquid circulation apparatus is stopped simultaneously with the start of the collection operation (foreign-matter collection sequence).

In step S204, the discharge valves 1 to 3 are opened, so that the liquid in the circulation system is released to the waste liquid container 12.

In step S205, the supply pump and the circulation pump are driven. Thus, the liquid in the circulation system is collected into the waste liquid container 12. In this case, the waste liquid containing the foreign matter captured by the first filter 15A is collected into the waste liquid container 12.

The time during which step S205 is performed is not particularly limited and can be selected as appropriate in accordance with the purpose. For example, step S205 can be performed for five seconds.

In step S206, the supply pump and the circulation pump are stopped. Thus, the liquid in the circulation system is stopped from being collected into the liquid container 11.

In step S207, the discharge valves 1 to 3 are close, so that the collection operation (foreign-matter collection sequence) terminates.

### Third Embodiment

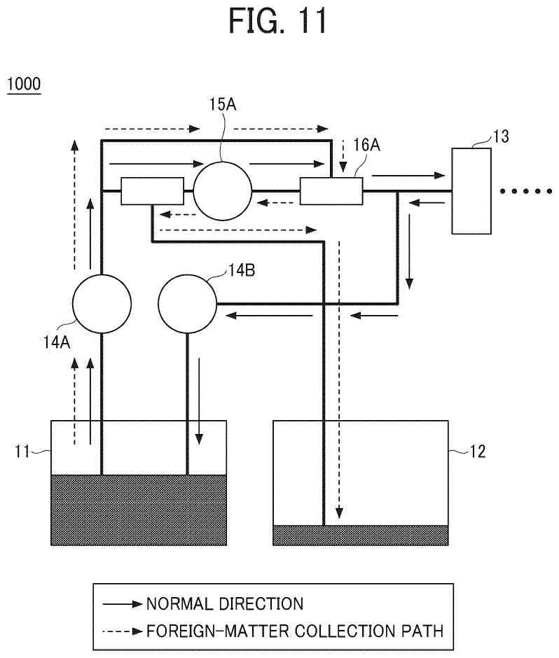

FIG. 11 is a schematic diagram illustrating a liquid circulation apparatus 1000 according to a third embodiment. In the following description of the liquid circulation apparatus 1000 according to the third embodiment, differences from the respective liquid circulation apparatuses 1000 according to the first embodiment and the second embodiment will be described and description of the already described matters will be partially omitted.

The liquid circulation apparatus 1000 according to the third embodiment includes a circulation path in which liquid circulates through a liquid discharge head 13.

As illustrated in FIG. 11, the circulation path includes a liquid container 11, a waste liquid container 12, a liquid discharge head 13, a first liquid feeder 14A, a second liquid feeder 14B, a first filter 15A, and a three-way valve 16A.

The third embodiment is different from the first embodiment and the second embodiment in that such a three-way valve 16A is disposed on the upstream side of the first filter 15A and another three-way valve 16A is disposed on the downstream side of the first filter 15A.

In the third embodiment, in a collection operation, the two three-way valves 16A are controlled to open or close such that the liquid is fed in the direction of a foreign-matter collection path illustrated in FIG. 11. In this state, the first liquid feeder 14A is driven, so that the foreign matter captured by the first filter 15A can be collected into the waste liquid container 12.

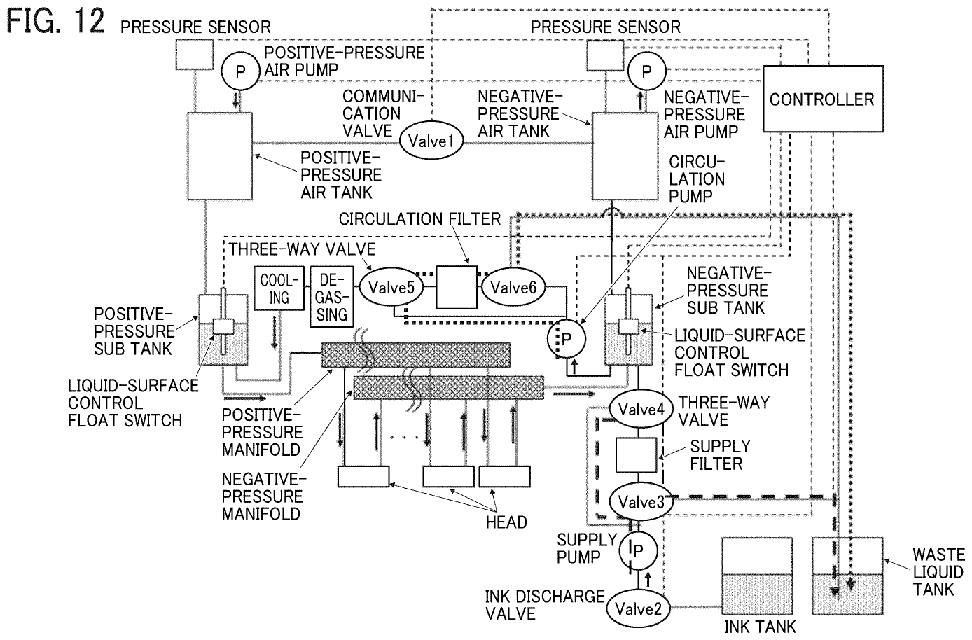

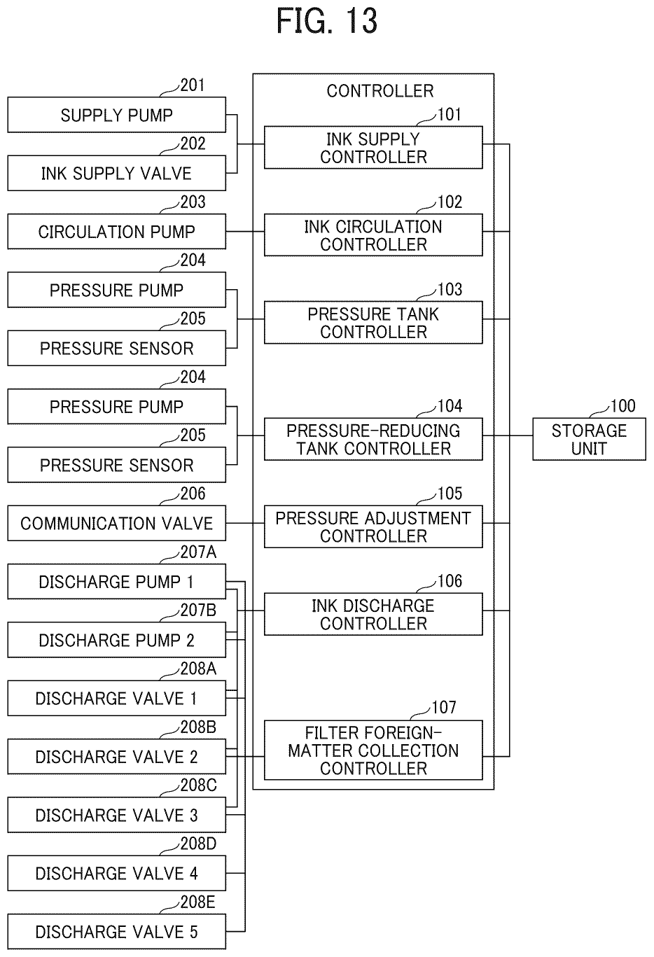

FIG. 12 is a schematic diagram of the liquid circulation apparatus according to the present embodiment. FIG. 13 is a block diagram illustrating a hardware block configuration of the liquid circulation apparatus according to the present embodiment. Referring to FIG. 12, the flow of liquid in a discharge operation is indicated with solid arrows, and the flow of liquid in the collection operation is indicated with broken arrows.

The liquid circulation apparatus according to the third embodiment includes a storage unit 100 as illustrated in FIG. 13, and the storage unit 100 is connected to a control unit that controls the liquid circulation apparatus.

The control unit includes an ink supply controller 101, an ink circulation controller 102, a pressure-tank controller 103, a pressure-reducing tank controller 104, a pressure adjustment controller 105, an ink discharge controller 106, and a filter foreign-matter collection controller 107.

The ink supply controller 101 is connected to a supply pump 201 and an ink supply valve 202 and controls the supply pump 201 and the ink supply valve 202.

Control of the supply pump 201 causes liquid to be supplied from the liquid container 11 to the liquid discharge head 13. Control of the ink supply valve 202 causes waste liquid containing foreign matter to be collected into the waste liquid container 12.

The ink circulation controller 102 is connected to a circulation pump 203 and controls the circulation pump 203.

The pressure-tank controller 103 is connected to a pressure pump 204 and a pressure sensor 205 and controls the pressure pump 204 and the pressure sensor 205.

The pressure-reducing tank controller 104 is connected to a pressure pump 204 and a pressure sensor 205 and controls the pressure pump 204 and the pressure sensor 205.

The pressure adjustment controller 105 is connected to a communication valve 206 and controls the communication valve 206.

The ink discharge controller 106 is connected to discharge pumps 207A and 207B and discharge valves 208A, 208B, 208C, 208D, and 208E, and controls the discharge pumps 207A and 207B and the discharge valves 208A, 208B, and 208C, 208D, and 208E.

The filter foreign-matter collection controller 107 is connected to the discharge pumps 207A and 207B and the discharge valves 208A, 208B, 208C, 208D, and 208E and controls the discharge pumps 207A and 207B and the discharge valves 208A, 208B, 208C, 208D, and 208E.

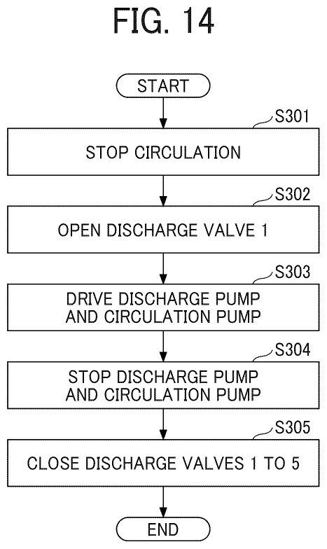

FIG. 14 is a flowchart illustrating an exemplary collection operation in a method for controlling the liquid circulation apparatus according to the present embodiment.

The collection operation in the method for controlling the liquid circulation apparatus (foreign-matter collection sequence) includes step S301 in which the liquid in the circulation path is stopped from circulating, step S302 in which discharge valves 1 to 5 are opened, step S303 in which a supply pump and a circulation pump are driven, step S304 in which the supply pump and the circulation pump are stopped, and step S305 in which the discharge valves 1 to 5 are close.

In step S301, the circulation of the liquid circulation apparatus is stopped simultaneously with the start of the collection operation (foreign-matter collection sequence).

In step S302, the discharge valves 1 to 5 are opened, so that the liquid in the circulation system is released to the waste liquid container 12.

In step S303, the supply pump and the circulation pump are driven. Thus, the liquid in the circulation system is collected into the waste liquid container 12. In this case, the waste liquid containing the foreign matter captured by the first filter 15A is collected into the waste liquid container 12.

The time during which step S303 is performed is not particularly limited and can be selected as appropriate in accordance with the purpose. For example, step S303 can be performed for five seconds.

In step S304, the supply pump and the circulation pump are stopped. Thus, the liquid in the circulation system is stopped from being collected into the liquid container 11.

In step S305, the discharge valves 1 to 5 are close, so that the collection operation (foreign-matter collection sequence) terminates.

A liquid circulation apparatus includes: a head to: discharge a liquid from a nozzle; and circulate the liquid that is not discharged from the nozzle; and a liquid container to: store the liquid to be supplied to the head; and store the liquid collected from the head; a waste liquid container to store waste liquid of the liquid collected from the head; a first liquid feeder to feed the liquid from the liquid container to the head in a first feeding direction; a second liquid feeder to feed the liquid from the head to the liquid container or the waste liquid container in a second feeding direction; a filter disposed at least: between the first liquid feeder and the head; or between the second liquid feeder and the head; and a three-way valve disposed: between the first liquid feeder and the waste liquid container; or between the second liquid feeder and the waste liquid container, to switch a path between: a circulation path to circulate the liquid from the head to the liquid container; or a waste liquid path to discharge a waste liquid from the filter to the waste liquid container.

The three-way valve is disposed downstream of the second liquid feeder in the second feeding direction; and the three-way valve branches a path downstream of the second liquid feeder in the second feeding direction into: a first path to the second liquid feeder; and a second path to the waste liquid container. The filter is coupled to both of the first liquid feeder and the second liquid feeder at an upstream side of the filter in the first feeding direction; and the filter is coupled to the head at a downstream side of the filter in the first feeding direction.

The liquid circulation apparatus further includes: couplers disposed on both of an upstream side and a downstream side of the filter in the first feeding direction, wherein the filter is disposed between the first liquid feeder and the head, and the three-way valve is disposed: between the filter and the head; and between the filter and the waste liquid container.

The filter is detachable from and attachable to the liquid circulation apparatus at the couplers, the filter is coupled to the first liquid feeder at an upstream side of the filter in the first feeding direction, and the filter is coupled to the three-way valve at a downstream side of the filter in the first feeding direction.

The liquid circulation apparatus further includes: another three-way valve disposed between the first liquid feeder and the filter, wherein the filter is disposed between the first liquid feeder and the head, the three-way valve is disposed on a downstream side of the filter in the first feeding direction, said another three-way valve is disposed on an upstream side of the filter in the first feeding direction, and said another three-way valve is couple to the waste liquid container.

According to one aspect of the present embodiment, provided can be a liquid circulation apparatus that enables an increase in the life of a filter and has a high foreign-matter collection effect.

Aspects of the present embodiment are, for example, as follows.

According to Aspect 1, a liquid circulation apparatus includes
a circulation path in which liquid circulates through a liquid discharge head,
the circulation path including:
a liquid container that stores the liquid;
a waste liquid container that stores waste liquid of the liquid;
a first liquid feeder that feeds the liquid from the liquid container to the liquid discharge head;
a second liquid feeder that feeds the liquid from the liquid discharge head to the liquid container or the waste liquid container;
a first filter disposed between the first liquid feeder and the liquid discharge head and between the second liquid feeder and the liquid discharge head; and
a three-way valve disposed between the second liquid feeder and the liquid container and between the second liquid feeder and the waste liquid container.

According to Aspect 2, in the liquid circulation apparatus of Aspect 1, the circulation path further includes a second filter disposed between the second liquid feeder and the liquid container and between the second liquid feeder and the waste liquid container.

According to Aspect 3, a liquid circulation apparatus includes
a circulation path in which liquid circulates through a liquid discharge head,
the circulation path including:
a liquid container that stores the liquid;
a waste liquid container that stores waste liquid of the liquid;
a first liquid feeder that feeds the liquid from the liquid container to the liquid discharge head;
a second liquid feeder that feeds the liquid from the liquid discharge head to the liquid container;
a filter disposed between the first liquid feeder and the liquid discharge head;
a coupler disposed on an upstream side of the filter and a coupler disposed on a downstream side of the filter; and
a three-way valve disposed between the filter and the liquid discharge head, the three-way valve being connected to the waste liquid container.

According to Aspect 4, a liquid circulation apparatus includes
a circulation path in which liquid circulates through a liquid discharge head,
the circulation path including:
a liquid container that stores the liquid;
a waste liquid container that stores waste liquid of the liquid;
a first liquid feeder that feeds the liquid from the liquid container to the liquid discharge head;
a second liquid feeder that feeds the liquid from the liquid discharge head to the liquid container;
a filter disposed between the first liquid feeder and the liquid discharge head; and
a three-way valve disposed on an upstream side of the filter and a three-way valve disposed on a downstream side of the filter,
the three-way valve, on the upstream side of the filter, being connected to the waste liquid container.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A liquid circulation apparatus comprising:
a head to:
discharge a liquid from a nozzle; and
circulate the liquid that is not discharged from the nozzle; and
a liquid container to:
store the liquid to be supplied to the head; and
store the liquid collected from the head;
a waste liquid container to store waste liquid of the liquid collected from the head;
a first liquid feeder to feed the liquid from the liquid container to the head in a first feeding direction;
a second liquid feeder to feed the liquid from the head to the liquid container or the waste liquid container in a second feeding direction;
a filter disposed at least:
betweenthe first liquid feeder and the head; or
between the second liquid feeder and the head; and
a three-way valve disposed:
between the first liquid feeder and the waste liquid container; or
between the second liquid feeder and the waste liquid container,
to switch a path between:
a circulation path to circulate the liquid from the head to the liquid container; or
a waste liquid path to discharge a waste liquid from the filter to the waste liquid container.

2. The liquid circulation apparatus according to claim 1, further comprising:
the three-way valve is disposed downstream of the second liquid feeder in the second feeding direction; and
the three-way valve branches a path downstream of the second liquid feeder in the second feeding direction into:
a first path to the second liquid feeder; and
a second path to the waste liquid container.

3. The liquid circulation apparatus according to claim 2,
wherein the filter is coupled to both of the first liquid feeder and the second liquid feeder at an upstream side of the filter in the first feeding direction; and
the filter is coupled to the head at a downstream side of the filter in the first feeding direction.

4. The liquid circulation apparatus according to claim 1, further comprising:
couplers disposed on both of an upstream side and a downstream side of the filter in the first feeding direction,
wherein the filter is disposed between the first liquid feeder and the head, and
the three-way valve is disposed:
between the filter and the head; and
between the filter and the waste liquid container.

5. The liquid circulation apparatus according to claim 4,
wherein filter is detachable from and attachable to the liquid circulation apparatus at the couplers,
the filter is coupled to the first liquid feeder at an upstream side of the filter in the first feeding direction, and
the filter is coupled to the three-way valve at a downstream side of the filter in the first feeding direction.

6. The liquid circulation apparatus according to claim 1, further comprising:
another three-way valve disposed between the first liquid feeder and the filter,
wherein the filter is disposed between the first liquid feeder and the head,
the three-way valve is disposed on a downstream side of the filter in the first feeding direction,
said another three-way valve is disposed on an upstream side of the filter in the first feeding direction, and
said another three-way valve is couple to the waste liquid container.

7. A liquid discharge apparatus comprising the liquid circulation apparatus according to claim 1.
